(19) United States
(12) Patent Application Publication
(10) Pub. No.: US 2010/0161701 A1
(43) Pub. Date: Jun. 24, 2010

(54) POLYNOMIAL REPRESENTATION FOR SYMBOLIC COMPUTATION

(75) Inventors: Xu Yang, Beijing (CN); Xiaolin Quan, Wuhan (CN); Dongmei Zhang, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/337,630

(22) Filed: Dec. 18, 2008

(51) Int. Cl. G06F 17/30; G06F 7/00

(52) U.S. Cl. 708/802; 707/E17.044

(57) ABSTRACT

A method for converting a polynomial expression to a data structure for symbolic computation. One or more variables in the polynomial expression may be determined. The variables may be stored in a first array. One or more terms in the polynomial expression may be determined. One or more exponents of the variables in each term may be determined. The exponents may be stored in a second array. One or more coefficients of the terms may be determined. The coefficients may be stored in a third array.

### BACKGROUND

Symbolic computation refers to the transformation of mathematical expressions in symbolic form. Mathematical expressions may also be transformed in numeric form; however, numeric form is less precise than symbolic. Transforming mathematical expressions in symbolic form is more precise than numeric form, because the numeric form may be calculated in floating-point computation, which has limited precision. Typical operations in symbolic computation include differentiation and integration, linear algebra and matrix calculus, operations with polynomials, or the simplification of algebraic expressions.

Because of the resources required for symbolic computation, software may be used to perform symbolic computation. Software approaches range from programs designed specifically for symbolic computation to programming languages designed with special libraries for performing symbolic computation. Programs or systems in this area which provide a language interface are called Computer Algebra Systems (CASes).

CASes are typically designed for applications in theoretical physics or mathematics. These systems may be used for applications where straightforward, but tedious or lengthy calculations are required.

### SUMMARY

Described herein are implementations of various technologies for converting a polynomial expression to a data structure for symbolic computation. In one implementation, a polynomial expression is broken down into three components and stored in sorted arrays. The three components may include variables, exponents, and coefficients.

Described herein are also implementations of various technologies for a data structure for representing a polynomial expression. In one implementation, the data structure may include a variables array, an exponents array, and a coefficients array. The variables array may include a list of all the variables in the polynomial expression. The exponents array may include the exponent values for all the variables in each term of the polynomial expression. The coefficients array may include the coefficients for all the terms in the expression.

In one implementation, multiple data structures may be formed using the same three arrays. However, the multiple data structures may be distinguished by the type of coefficients found in the polynomial expression. The coefficient types may include integers, rational numbers, finite field lists, radical numbers, imaginary numbers, mathematical constants, and even variables within the expression.

The claimed subject matter is not limited to implementations that solve any or all of the noted disadvantages. Further, the summary section is provided to introduce a selection of concepts in a simplified form that are further described below in the detailed description section. The summary section is not intended to identify key features or essential features of the claimed subject matter, nor is it intended to be used to limit the scope of the claimed subject matter.

### BRIEF DESCRIPTION OF THE DRAWINGS

FIG. 1 illustrates a schematic diagram of a computing system in which various technologies described herein may be incorporated and practiced.

FIG. 2 illustrates a flow chart of a method for converting a polynomial expression to a data structure for symbolic computation in accordance with various implementations of the technologies described herein.

FIG. 3 illustrates a flow chart of a step for storing exponents of the polynomial expression in an array in accordance with various implementations of the technologies described herein.

FIG. 4 illustrates the data structure for symbolic computation in accordance with implementations of various technologies described herein.

### DETAILED DESCRIPTION

In general, one or more implementations of various technologies described herein are directed to converting a polynomial expression to a data structure for symbolic computation. The various implementations will be described in more detail in the following paragraphs.

Implementations of various technologies described herein may be operational with numerous general purpose or special purpose computing system environments or configurations. Examples of well known computing systems, environments, and/or configurations that may be suitable for use with the various technologies described herein include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The various technologies described herein may be implemented in the general context of computer-executable instructions, such as program modules, being executed by a computer. Generally, program modules include routines, programs, objects, components, data structures, etc. that perform particular tasks or implement particular abstract data types. The various technologies described herein may also be implemented in distributed computing environments where tasks are performed by remote processing devices that are linked through a communications network, e.g., by hardwired links, wireless links, or combinations thereof. In a distributed computing environment, program modules may be located in both local and remote computer storage media including memory storage devices.

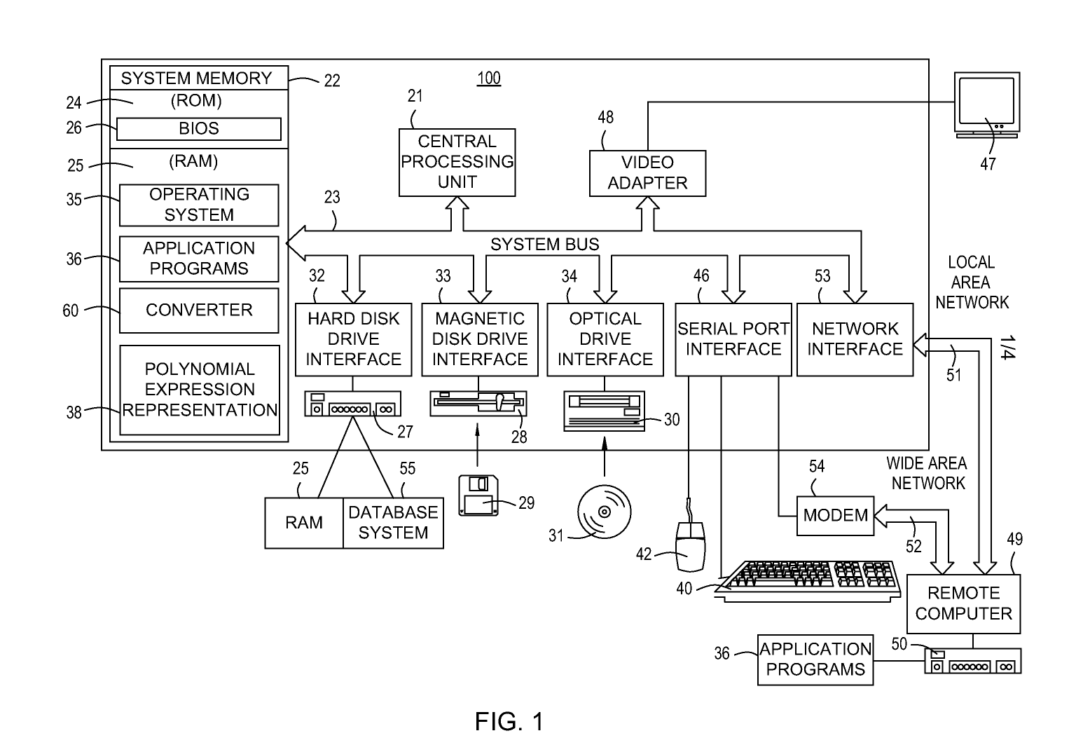

FIG. 1 illustrates a schematic diagram of a computing system 100 in which the various technologies described herein may be incorporated and practiced. Although the computing system 100 may be a conventional desktop or a server computer, as described above, other computer system configurations may be used.

The computing system 100 may include a central processing unit (CPU) 21, a system memory 22 and a system bus 23 that couples various system components including the system memory 22 to the CPU 21. Although only one CPU is illustrated in FIG. 1, it should be understood that in some implementations the computing system 100 may include more than one CPU. The system bus 23 may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. The system memory 22 may include a read only memory (ROM) 24 and a random access memory (RAM) 25. A basic input/output system (BIOS) 26, containing the basic routines that help transfer information between elements within the computing system 100, such as during start-up, may be stored in the ROM 24.

The computing system 100 may further include a hard disk drive 27 for reading from and writing to a hard disk, a magnetic disk drive 28 for reading from and writing to a removable magnetic disk 29, and an optical disk drive 30 for reading from and writing to a removable optical disk 31, such as a CD ROM or other optical media. The hard disk drive 27, the magnetic disk drive 28, and the optical disk drive 30 may be connected to the system bus 23 by a hard disk drive interface 32, a magnetic disk drive interface 33, and an optical drive interface 34, respectively. The drives and their associated computer-readable media may provide nonvolatile storage of computer-readable instructions, data structures, program modules and other data for the computing system 100.

Although the computing system 100 is described herein as having a hard disk, a removable magnetic disk 29 and a removable optical disk 31, it should be appreciated by those skilled in the art that the computing system 100 may also include other types of computer-readable media that may be accessed by a computer. For example, such computer-readable media may include computer storage media and communication media.

Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computing system 100.

Communication media may embody computer readable instructions, data structures, program modules or other data in a modulated data signal, such as a carrier wave or other transport mechanism and may include any information delivery media. The term “modulated data signal” may mean a signal that has one or more of its characteristics set or changed in such a manner as to encode information in the signal. By way of example, and not limitation, communication media may include wired media such as a wired network or direct-wired connection, and wireless media such as acoustic, RF, infrared and other wireless media. Combinations of the any of the above may also be included within the scope of computer readable media.

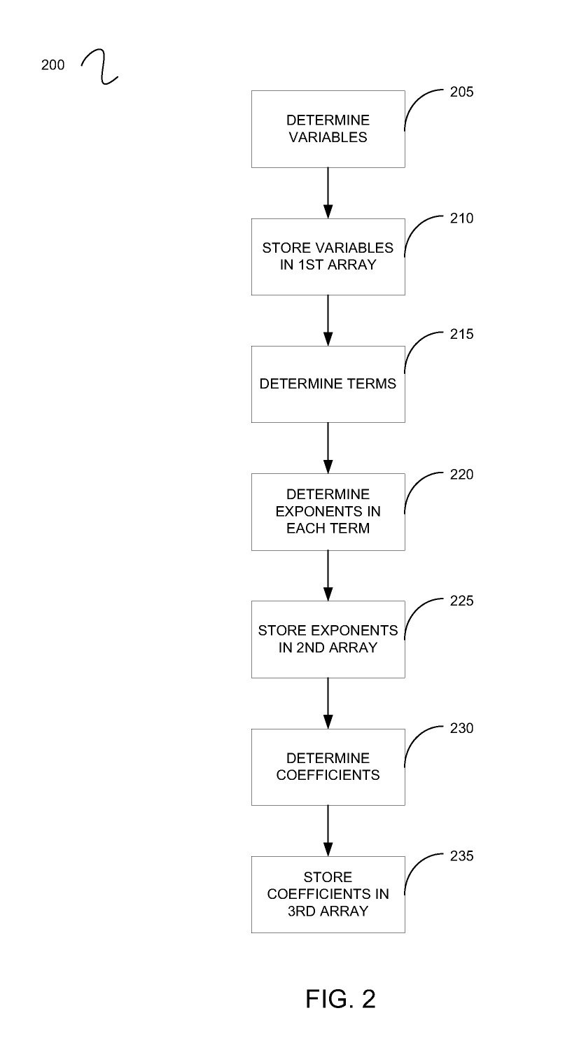

A number of modules may be stored on the hard disk, magnetic disk 29, optical disk 31, ROM 24 or RAM 25, including an operating system 35, one or more application programs 36, a converter 60, polynomial expression representation 38 and a database system 55. The operating system 35 may be any suitable operating system that may control the operation of a networked personal or server computer, such as Windows® XP, Mac OS® X, Unix-variants (e.g., Linux® and BSD®), and the like. The polynomial expression representation 38 may include data structures for performing symbolic computation on a polynomial expression. The converter 60 may convert a polynomial expression to the polynomial expression representation 38. The converter 60 and the polynomial expression representation 38 will be described in more detail with reference to FIGS. 2-4 in the paragraphs below.

A user may enter commands and information into the computing system 100 through input devices such as a keyboard 40 and pointing device 42. Other input devices may include a microphone, joystick, game pad, satellite dish, scanner, or the like. These and other input devices may be connected to the CPU 21 through a serial port interface 46 coupled to system bus 23, but may be connected by other interfaces, such as a parallel port, game port or a universal serial bus (USB). A monitor 47 or other type of display device may also be connected to system bus 23 via an interface, such as a video adapter 48. In addition to the monitor 47, the computing system 100 may further include other peripheral output devices, such as speakers and printers.

Further, the computing system 100 may operate in a networked environment using logical connections to one or more remote computers, such as a remote computer 49. The remote computer 49 may be another personal computer, a server, a router, a network PC, a peer device or other common network node. Although the remote computer 49 is illustrated as having only a memory storage device 50, the remote computer 49 may include many or all of the elements described above relative to the computing system 100. The logical connections may be any connection that is commonplace in offices, enterprise-wide computer networks, intranets, and the Internet, such as local area network (LAN) 51 and a wide area network (WAN) 52.

When using a LAN networking environment, the computing system 100 may be connected to the local network 51 through a network interface or adapter 53. When used in a WAN networking environment, the computing system 100 may include a modem 54, wireless router or other means for establishing communication over a wide area network 52, such as the Internet. The modem 54, which may be internal or external, may be connected to the system bus 23 via the serial port interface 46. In a networked environment, program modules depicted relative to the computing system 100, or portions thereof, may be stored in a remote memory storage device 50. It will be appreciated that the network connections shown are exemplary and other means of establishing a communications link between the computers may be used.

It should be understood that the various technologies described herein may be implemented in connection with hardware, software or a combination of both. Thus, various technologies, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the various technologies. In the case of program code execution on programmable computers, the computing device may include a processor, a storage medium readable by the processor (including volatile and non-volatile memory and/or storage elements), at least one input device, and at least one output device.

One or more programs that may implement or utilize the various technologies described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations.

FIG. 2 illustrates a flow chart of a method 200 for converting a polynomial expression to a data structure for symbolic computation in accordance with various implementations of the technologies described herein. In one implementation, the converter 60 may be configured to perform the steps described with reference to method 200. It should be understood that while the operational flow diagram of the method 200 indicates a particular order of execution of the operations, in some implementations, the operations might be executed in a different order.

At step 205, the converter 60 may determine what all the variables are within a polynomial expression. The polynomial expression may be an expression of terms that are constructed from variables and constants, using mathematical operations, and constant, non-negative, whole number exponents. For example, given the following polynomial expression:

x²+3xy−1=0

The converter 60 may determine that the variables are x and y.

At step 210, the variables may be stored within a first array. In one implementation, a number may be assigned to each variable based on the alphabetic order of the variables. For example, for the example polynomial above, the variables x and y may be assigned the numbers 1 and 0, respectively. The assigned numbers may then be sorted in ascending order and stored in the first array, accordingly. As such the first array may contain the variables as follows: [0, 1].

At step 215, the converter 60 may determine the terms of the polynomial. A term is a number, variable, or the product of several numbers and/or variables separated from another term by a + or − sign in an overall expression. In the example polynomial described above, the terms are x², 3xy, and 1.

At step 220 the converter 60 may determine the exponents of the variables in each term. Specifically, for each term, the converter may determine the exponent for each variable in the polynomial expression. For example, in the first term described above, x², the converter 60 may determine that the exponent for the x variable is 2, and the exponent for the y variable is 0, etc.

At step 225, the converter 60 may store the exponents in a second array. In one implementation, the second array may include an entry for each term. The entry may contain the exponents for each variable in the polynomial for the term.

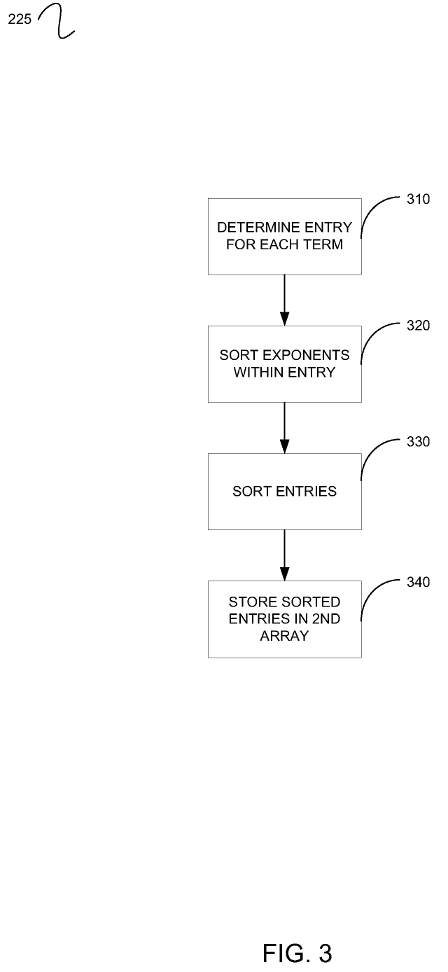

For the example polynomial, the converter 60 may create a second array as follows: [2,0; 1,1; 0,0]. The first entry, “2,0” is for the first term, x². The “2” indicates the exponent for x is 2 in the first term. Similarly, the “0” indicates that the exponent for y is 0 in the first term. Step 225 is described in greater detail with reference to FIG. 3.

At step 230, the converter 60 may determine the coefficients of the terms in the polynomial. For the example polynomial, the converter 60 may determine that the coefficients are 1, 3, and −1.

At step 235, the converter may store the coefficients in a third array. In one implementation, the coefficients may be stored according to the order of the terms represented in the second array. For example, if the second array contains [2,0; 1,1; 0,0], representing the order of terms: x², 3xy, and 1, the converter may store the third array in the following order: [1, 3, −1]. Similarly, if the second array contains [1,1; 0,0; 2.0], representing the order of terms: 3xy, 1, and x², the converter may store the third array in the following order: [3, −1, 1].

FIG. 3 illustrates a flow chart of step 225 for storing exponents of the polynomial expression in an array in accordance with various implementations of the technologies described herein. As stated previously, the converter 60 may perform the step 225.

At step 310, the converter 60 may determine an entry for each term in the polynomial expression. As stated previously, the entry includes an exponent for each variable in the polynomial expression. For example, the converter 60 may determine entries for the example equation, x²+3xy−1=0. Because there are two variables in the polynomial, x, y, each entry may contain two exponents. Accordingly, the converter 60 may determine a first entry for the first term, x², to be: 2,0. The 2 may represent the exponent for the x variable. The 0 may represent the exponent of the y variable, i.e., y⁰=1. Similarly, the converter 60 may determine the second and third entries, for the respective terms 3xy and 1, to be 1,1; and 0,0.

At step 320, the converter 60 may sort the exponents within the entry according to a reverse alphabetic order of the exponents' variables. In the scenario described above, each entry is in alphabetic order of the exponents' variables. Accordingly, the converter 60 may reverse the exponents' order within the entries to be 0,2; 1,1; and 0,0.

In addition to sorting the exponents within the entries, the entries may be sorted within the array. At step 330, the converter 60 may sort the entries in descending order according to the reverse alphabetic order of the variables. In other words, the entries are sorted by comparing the first exponent values, then the second exponent values, etc. For example, the entries described above: 0,2; 1,1; and 0,0 may be sorted as follows: 1,1; 0,2; 0,0. At step 340, the converter 60 may store the sorted entries in the second array.

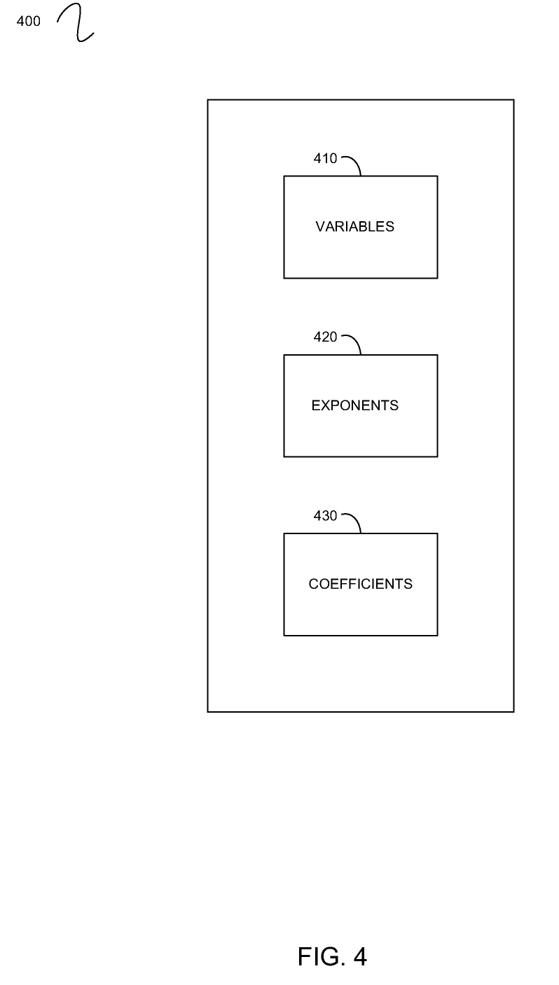

FIG. 4 illustrates a data structure 400 for symbolic computation in accordance with implementations of various technologies described herein. The data structure 400 may contain a variables array 410, an exponents array 420, and a coefficients array 430.

The variables array 410 may represent the first array described above. As such, the variables array 410 may contain all the variables within the polynomial expression.

The exponents array 420 may represent the second array described above. As such, the exponents array 420 may contain the exponents of the variables in each term of the polynomial expression.

The coefficients array 430 may represent the third array described above. As such, the coefficients array 430 may contain the coefficients for each term in the polynomial expression.

In one implementation, multiple data structures 400 may be used according to the domain of the coefficients. Advantageously, by separating the data structures 400 by coefficient domains, associated functions of the data structures may be simplified to operate within a restricted domain. For example, some functions may be written differently for an integer domain, as opposed to a finite field list domain. A finite field list Zₚ, may contain integer values from −p/2 through +p/2. For example Z₅=[−2, −1, 0, 1, 2].

The multiple data structures 400 may include one data structure 400 each where the coefficient values include: 1) integers, 2) rational numbers, 3) finite field lists, 4) complex numbers, radical numbers, or mathematical constants. Mathematical constants may include values, such as, pi and Euler's number, e.

Additionally, in one implementation, some of the variables within the polynomial expression may be treated as coefficients. In such an implementation, there may be a first portion of variables in the polynomial expression that are stored in the variables array. Similarly, a second portion of the variables in the polynomial expression may be stored in the coefficients array.

As such, the data structures 400 may also include one data structure each where the coefficient values include: 5) integers and variables, 6) rational numbers and variables, and 7) complex numbers, radical numbers, or mathematical constants; and, variables.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for converting a polynomial expression to a data structure for symbolic computation, comprising:
determining one or more variables in the polynomial expression;
storing the variables in a first array;
determining one or more terms in the polynomial expression;
determining one or more exponents of the variables in each term;
storing the exponents in a second array;
determining one or more coefficients of the terms; and
storing the coefficients in a third array.

2. The method of claim 1, wherein storing the exponents in the second array comprises:
determining an entry for each term, wherein the entry comprises an exponent for each variable in the polynomial expression;
sorting the exponents within the entry according to a reverse alphabetic order of the variables;
sorting the entries in descending order according to a reverse alphabetic order of the variables; and
storing the sorted entries in the second array.

3. The method of claim 1, wherein storing the variables in the first array comprises:
assigning a number for each variable based on an alphabetic order of the variables; and
sorting the numbers in ascending order; and
storing the sorted numbers in the first array.

4. The method of claim 3, wherein storing the exponents in the second array comprises:
determining an entry for each term, wherein the entry comprises an exponent for each variable in the polynomial expression;
sorting the exponents within the entry according to a reverse alphabetic order of the variables;
sorting the entries in descending order according to a reverse alphabetic order of the variables; and
storing the sorted entries in the second array.

5. The method of claim 4, wherein storing the coefficients in the third array comprises storing the coefficients based on an order of the entries in the second array.

6. A memory for storing data for access by an application program being executed on a processor, the memory comprising: a data structure for representing a polynomial expression having one or more terms, the data structure comprising:
a first array for one or more variables in the polynomial expression;
a second array for one or more exponents of the variables in each term; and
a third array for one or more coefficients for each term.

7. The memory of claim 6, wherein the coefficients comprise one or more integers.

8. The memory of claim 6, wherein the coefficients comprise one or more rational numbers.

9. The memory of claim 6, wherein the coefficients comprise one or more finite field lists.

10. The memory of claim 6, wherein the coefficients comprise:
complex numbers;
radical numbers;
imaginary numbers;
mathematical constants; or
combinations thereof.

11. The memory of claim 10, wherein the mathematical constants comprise:
pi;
Euler's number; or
combinations thereof.

12. The memory of claim 6, wherein the variables are represented as one or more numbers.

13. The memory of claim 12, wherein the numbers are sorted in ascending order.

14. The memory of claim 6, wherein the data structure is used in symbolic computation.

15. The memory of claim 6, wherein the symbolic computation comprises factorization, greatest common divisor, resultant computation or combinations thereof.

16. The memory of claim 6, wherein the exponents of each variable are sorted in descending order.

17. A memory for storing data for access by an application program being executed on a processor, the memory comprising: a data structure for representing a polynomial expression having one or more terms, the data structure comprising:
a first array of a first portion of one or more variables in the polynomial expression;
a second array of one or more exponents of the first portion of variables in each term; and
a third array of one or more coefficients for each term, the coefficients having a second portion of the one or more variables.

18. The memory of claim 17, wherein the coefficients comprise one or more integers and the second portion of variables.

19. The memory of claim 17, wherein the coefficients comprise one or more rational numbers and the second portion of variables.

20. The memory of claim 17, wherein the coefficients comprise one or more finite field lists and the second portion of variables.
